(19) United States
(12) Patent Application Publication
(10) Pub. No.: US 2019/0087547 A1
(43) Pub. Date: Mar. 21, 2019

(54) DATA CAPTURE METHOD

(71) Applicant: Go Daddy Operating Company, LLC, Scottsdale, AZ (US)

(72) Inventors: Bennett I. Oscar Collen, Boston, MA (US); Christopher Murdock, New York, NY (US)

(21) Appl. No.: 16/132,120

(22) Filed: Sep. 14, 2018

Related U.S. Application Data
(60) Provisional application No. 62/559,194, filed on Sep. 15, 2017.

(51) Int. Cl. G06F 21/10; G06Q 50/18; H04L 9/06

(52) U.S. Cl. CPC G06F 21/10; H04L 2209/38; H04L 9/0637; G06Q 50/184

(57) ABSTRACT

In order to enforce and protect trademark rights, companies must be able to prove when, where, and how their trademarks are being used. The present invention is an online platform that allows companies to create timestamped, immutable records of trademark use, powered by blockchain technology.

### CROSS-REFERENCE TO RELATED PATENT APPLICATIONS

This application claims priority to U.S. Application No. 62/559,194 titled “Data Capture Method” filed on Sep. 15, 2017 which is incorporated herein by reference in its entirety.

### FIELD OF THE INVENTION

The present invention relates to recording supporting documents in a blockchain of a commercial use of a trademark in an efficient and verifiable manner.

### BACKGROUND

Almost all goods and services sold in the $72.8 trillion dollar global economy are sold under trademarks. A trademark is any word, name, symbol or design, which serves to identify the source of goods and services sold in commerce as originating from a particular owner (under certain circumstances, trademarks may also be sounds, colors, or even smells). The principal function of a trademark is to distinguish goods and services from each other to prevent confusion amongst consumers in the marketplace.

Fortune 100 companies and startups alike have names, logos, and slogans that they use to sell their products and services. Not only do most companies have trademarks, but trademarks are often a company's most valuable asset; the size of a company's trademark portfolio has been found to be a more consistent indicator of innovation than patent count or R&D expenditure. However, tracking and storing the necessary legal documents to show the validity of a company's trademarks is very cumbersome.

### SUMMARY OF THE INVENTION

In order to enforce and protect trademark rights, companies must be able to prove when, where, and how their trademarks are being used. The present invention is an online platform that allows companies to create timestamped, immutable records of trademark use, powered by blockchain technology. The present invention's “ChainMark” protection system is faster, more affordable, and more secure than existing methods of proving trademark use.

The present invention is building a decentralized ecosystem that will provide secure, low-cost trademark protection for the entire lifecycle of a trademark; from clearance to inception, to federal registration, to monitoring, to enforcement, to licensing, to transfers of ownership, and sale.

The above features and advantages of the present invention will be better understood from the following detailed description taken in conjunction with the accompanying drawings.

### BRIEF DESCRIPTION OF THE DRAWINGS

FIG. 1 is a flowchart illustrating, step by step, a non-limiting example of one embodiment of practicing the invention.

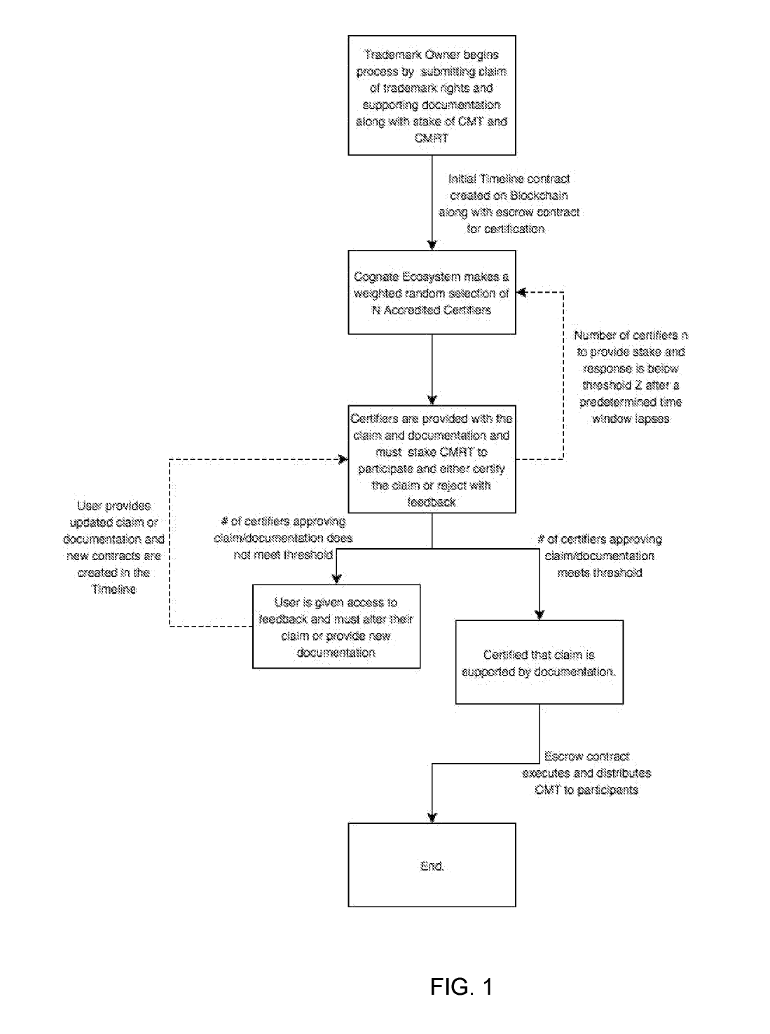

### DETAILED DESCRIPTION

The present inventions will now be discussed in detail with regard to the attached drawing FIGURES that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Concept of “Use”, Proving, and Enforcing Trademark Rights

Actual Use

Essential to enforcement and protection of trademarks is the concept of “use-in-commerce,” or “actual use.” Use is achieved when a trademark is Used in connection with goods or services, offered for sale in commerce. More simply, “Use” is achieved when a company uses a mark to sell goods or services to customers.

Each country (or jurisdiction) has its own laws that dictate how companies earn and maintain trademark rights, but the concept of trademark Use usually play a central role. In general, countries either adhere by the “first-to-use” system (also known as “common law”), or “first-to-file.”

Currently companies prove trademark Use through a combination of physical and digital records, which can easily be forged or questioned, and governmental trademark registrations, which are slow and expensive (and may still require proof of trademark Use to be enforced or maintained).

Large Enterprises

Companies with portfolios of hundreds or thousands of trademarks need to be able to document proof of trademark Use for every mark, in every jurisdiction in which they Use the mark, but lack a scalable and secure method for doing so.

Small and Medium Enterprises

Startups and small businesses face the same problems as larger companies, but lack their resources. A budget-constrained startup or small business doesn't have the luxury of time or financial resources required to participate in federal trademark registration systems, nor devise sophisticated systems for managing and tracking trademark Use. These companies iterate rapidly and generate many product names, slogans, logos, and possibly even several company names. They may choose to file for federal registration for their company name, but only when they can justify the cost.

In “first-to-use” jurisdictions (like the United States, India, and the United Kingdom) trademark rights are earned through Use of a mark alone. These are known as “common law” trademark rights, or “rights of first use.” In these countries, priority is given to the first user of a mark, and unregistered common law rights can supersede the rights obtained by marks registered with the federal government. In these countries, it is especially critical for companies to prove not only that their mark is in Use, but when Use began and where it is in Use.

In “first-to-file” jurisdictions trademark rights are derived solely through registration with the federal government. Though rights are initially earned through registration with the government in these countries, companies must be able to prove that they have achieved Use of a mark in order to maintain their rights. In most of these first-to-file countries the proof is required either three or five years from the registration date.

Jurisdiction

Since each country has its own trademark laws and systems for enforcing trademark rights, companies must be able to prove their Use in each country in which they operate. Traditionally this meant filing for federal trademark registration in every country that their goods or services are offered.

In the United States, trademark rights can even vary by region. A company operating exclusively in the southeastern United States may have earned common law trademark rights in that region, but would have no valid claim to their mark in the northwestern United States if they have not conducted business in that region. As a result, companies must be able to prove their trademark Use in each region in which they operate—made even more complicated by the fact that there aren't explicitly-defined regions in which a company must conduct business in order for their mark to be considered “in Use” in that region.

Classification

Trademark rights are also broken down by industry or “classification” or “class.” Since the purpose of a trademark is to avoid confusion amongst customers, it is reasonable that two companies can use identical trademarks in completely non-related industries, and there will be no likelihood of confusion amongst consumers.

Currently, companies must pay a separate application fee for each classification in which they are claiming Use. If a restaurant owner files for federal trademark protection for their logo in Class 43 (Hotels and Restaurants), and wants to start selling their signature steaks with local butcher shops under the same logo, she must file a separate trademark application in order to protect the mark in Class 29 (Meats and Processed Foods).

The internet led to an explosion in e-commerce, allowing organizations to easily market and ship their goods and services to a worldwide audience. As the global economy becomes more interconnected, proving and clearing trademark Use in multiple jurisdictions becomes more important than ever. This is evidenced by the uptick in trademark registrations, the number of trademarks has more than doubled since 2000.

Existing Systems for Proving Use

Over the years companies have developed several “do-it-yourself” solutions for documenting and proving trademark Use. The classic example of this is a company mailing themselves proof of their trademark Use to create a sealed, timestamped proof of existence.

Companies also keep physical documents that prove their trademark Use (e.g. receipts, invoices, and promotional materials). In order to unequivocally prove Use, these specimens must be kept for every trademark in the company's portfolio to prove continuing Use in every jurisdiction and classification. These specimens are not a reliable way to prove trademark Use since they can easily be misplaced, destroyed, or forged. Some companies with large trademark portfolios have entire rooms dedicated to housing physical specimens proving trademark Use.

The most widely accepted way to prove trademark Use and subsequent rights are government trademark registrations. Government registrations tend to be slow, costly, and complicated. Because of the relatively high stakes and slow process, companies choose to hire attorneys to help with trademark applications to increase the likelihood that their application is accepted. This makes an already-expensive process even more so.

The present invention uses blockchain technology to create permanent, timestamped records of trademark Use for both federally registered and unregistered trademarks. These records can be used to prove and enforce trademark rights. All marks recorded using the present invention gain the right to use a special designation. As a non-limiting example, all of the recorded marks may use Cognate's CM certification mark (ex: CognateCM), and can easily be accessed and managed via the online platform.

The present invention is faster, more affordable, and more secure than governmental trademark registrations. A flexible record system allows companies to add new proofs to existing marks as they continue to use their mark, expand into new jurisdictions, or use their mark in a new way. This creates a comprehensive and defensible timeline of trademark Use.

Trademarks must be Used continuously in order to retain trademark rights, lest they be marked abandoned. With the present invention, startups and small businesses can now create timestamped, permanent records of their trademark rights quickly and affordably—no matter how many trademarks they use.

Types of Proof Recorded

Unequivocal proof of common law rights may be achieved, as the present invention creates timestamped, permanent records of trademark Use, which may be used to prove Use of unregistered marks and subsequent “common law” rights in a cost-effective and scalable manner.

Proof of First Use may be achieved by the present invention, when marks are registered on the day that “First Use” is achieved, The present invention's records may be used to prove priority ownership over junior users of a mark—this is especially important in common law jurisdictions, where “rights of First Use” can supersede federally registered marks.

Prove Use in multiple regions (Common Law) may be achieved in the U.S. and other “first-to-use” countries, common law rights may be limited to the geographic region in which a company operates, and the regions into which it may “naturally expand.” As companies achieve Use in multiple regions, they can log records to prove trademark Use in each region to show the scope of their use.

Prove Use in multiple Jurisdictions may be achieved when companies offer their goods or services in multiple countries, they can create records to prove their trademark Use on a global scale without filing separate federal applications in each country. Proof documents that show Use in the new jurisdiction(s) can be amended to the existing registration.

Prove Use in multiple Classes may be achieved when companies begin Using an existing mark in a new classification, they can create a record to reflect the new Use of their mark without creating a separate application. Proof documents can be amended to the existing registration.

Record use of “generic” marks may be achieved. “Generic” or “descriptive” marks may not be eligible for governmental trademark registration until the mark acquires “secondary meaning” (i.e. they become distinctive or well-known enough to serve as trademarks). Using the present invention, mark owners can create explicit records and history of Use for these marks as they acquire distinctiveness.

No rejections based on third party claims may be achieved. Applications for governmental registration are often wrongly rejected based on another party's prior registration. Using the present invention, as long as a mark owner can demonstrate Use in commerce, the mark is eligible for registration.

Prove continuing Use may be achieved. In order to enforce and maintain trademark rights, mark owners must be able to prove not only when trademark Use began, but that the mark has been used continuously in the same manner. Mark owners can log multiple records over time to prove continuing Use of both registered and unregistered marks, creating a comprehensive timeline of trademark Use.

The stored certified records may be used to prove Use in case of trademark infringement or conflict. Since records on the present invention are timestamped and immutable, they can be used as evidence to prove trademark ownership and rights in case of trademark infringement or other forms of trademark conflict, helping resolve those conflicts more quickly and cost-effectively.

Prove Use when filing application or renewal may be achieved when filing a Use-based trademark application with a government entity, or a renewal of an existing registered trademark, proof of trademark use is required. The present invention records can be used to effortlessly prove Use.

Regarding UDRP Disputes, trademark owners are entitled to certain rights when it comes to domain name ownership. Disputes over domain name ownership are resolved by the Uniform Domain Resolution Policy or UDRP. As with other trademark-related conflicts, mark owners must be able to prove when use of their mark began, or risk losing their domain to a cybersquatter. The present invention records can be used to prove use in UDRP disputes.

CM Mark—The present invention reviews each mark and specimen submitted to the system to check if the trademark owner has evidence to support their trademark claim of trademark Use in commerce. This may be done using an algorithm developed based on the guidelines put forth in the U.S. Patent and Trademark Office's Trademark Manual of Examining Procedure, and input from trademark attorneys.

Trademarks that meet the present invention's standards to qualify as a trademark “in Use in commerce” are entitled to use the CM Certification Mark with their mark (ex: CognateCM).

The CM Mark may serve several purposes. The CM Mark may put potential infringers on notice that the mark is in Use, and being protected as a trademark by the owner. The CM Mark may serve as a visual representation that the mark has been registered on the present invention, and that information about the mark's Use can be found in a database, acting as a deterrent to potential infringers.

The present invention may provide an API or hyperlink that will lead to a mark's entry in the database for the owner. This will allow customers, partners, and potential infringers to see and explicit history of mark ownership and Use. This could come in the form of a HTML or JavaScript code snippet for embedded calls or a server-to-server call for more integrated setups. The present invention may also allow explicit usage history to be hidden or encrypted, per the request of the mark owner.

Monitoring

Once a company has established trademark rights, they may be obligated by law to actively protect and enforce their trademarks against infringement. If a company isn't proactive in policing their mark, they risk losing it altogether. To this end, the present invention provides a trademark monitoring service that alerts users via email report to potential conflicts with their trademark or brand.

Trademark Infringement and Other Conflicts

Clearance

When selecting a trademark for a new company, product, or initiative, a company should do a clearance search to make sure that their new mark doesn't infringe on the rights of existing mark holders. This is an expensive endeavor. Companies that aspire to do business in multiple countries must pay extra to clear their mark in each jurisdiction in which they plan to operate.

In big companies, this creates tension between the marketing and legal teams, as marketers must clear new marks with the legal department before they can be used. Startups and small businesses often can't afford a full “knockout” clearance search performed by a firm that specializes in such searches. As a result they have to perform their own searches, which are often inadequate. Some companies don't do any clearance at all, which can lead to expensive legal proceedings and losing the right to use the trademark.

Because the majority of marks in Use in the United States are never registered with the USPTO, there is no one, centralized database of trademarks in Use. Clearance searches routinely encompass tens of thousands of both digital and analog sources (like newspapers and magazines) looking for possible conflicts.

Counterfeit

Counterfeit goods are an enormous rapidly-expanding problem in the trademark community, which disproportionately affects small businesses. Counterfeiters have traditionally focused on a select few luxury or ultra-luxury brands. But due to the proliferation of online sales and shipping, and the current economic climate, they are now targeting small to mid-market brands as well.

Vendors who use online marketplaces such as Amazon®, eBay®, and Etsy® often find their trademarks being used by unauthorized third parties selling counterfeit goods. Smaller brands are less risky to the counterfeiters because big luxury brands have aggressive anti-counterfeiting and infringement watch and protection programs. Smaller brands generally can't afford these safeguards, making them easy targets.

Illegally selling items at lower price tiers, closer to the goods' actual retail value, may be even more profitable than selling high-end items significantly below retail, and the number of affected brands is growing daily.

The internet has enabled counterfeiters to be more effective since they have instant access to worldwide customer base, can easily create professional-looking websites, and social media profiles, and can use Search Engine Optimization (SEO) techniques to out-rank small brand owners in web searches.

E-commerce sites enable “new-age counterfeiters” to engage in counterfeiting with relatively low effort and expense. Through drop-shipping, unauthorized third parties can sell goods without ever coming into contact with them. drop-shippers may also sell a company's actual goods, so it may not technically be infringement, but it can have detrimental effects on a company's brand. Drop-shippers can mark up prices, provide poor or no customer service, and result in an increased number of returned items.

Drop-shipping is defined as when a seller posts an item for sale, accepts payment and fills the order through a supplier that ships directly to the customer. The volume of counterfeit goods sold online is primed to surpass number of goods sold in physical markets (street vendors)

Enforcement

Companies retroactively scramble to find a specimen that unequivocally proves their trademark Use. Claimed dates of first Use on federal registrations must still be supported with proof of Use in the event of a trademark conflict.

Statistics on Trademark Conflict

The majority of trademark conflicts never reach litigation, and are settled out of court. Untold millions are lost by companies each year in time, attorney fees, and settlements.

The present invention is preferably a fully-decentralized system of recording and certifying trademark Use and ownership is the future of global trademark protection. A decentralized platform will provide a greater level of trust and value to the users, will allow the platform to scale more efficiently and will help build a community around the ecosystem. Decentralization is realized by introducing a tokenized system in which users are able to interact with the open platform. Users will stake CM Tokens (CMT) against their trademark claim in order to have it certified by a community.

The present invention maintains a web application for trademark owners to create comprehensive, timestamped, permanent records of their trademark Use (referred to as a “Timeline”) in the present invention ecosystem. After initial creation and submission of a proof document or supporting documents (“specimen”) via the web application, the data may undergo a CM Certification Process to ensure the documentation provided supports the trademark owner's claimed trademark rights. Once CM Certified, the trademark owner receives a digital certificate certifying trademark registration on the present invention and the claim and documentation are permanently recorded on a blockchain, such as, as a non-limiting example, the Ethereum blockchain in the form of a Timeline smart contract.

For documentation in image format or similar, the present invention may create a proof of existence using any desired hashing algorithm, such as, as a non-limiting example, the SHA-256 hashing algorithm. The hash generated by SHA-256 may be stored on the blockchain and may then be used to prove that a user's documentation existed at the timestamp created by the smart contract.

After the initial smart contract creation, trademark owners can add additional claims and supporting documentation regarding continued trademark Use, Use in new jurisdictions, and/or Use in new classifications. These claims and supporting specimens are appended to the initial Timeline contract created for the user's trademark without altering the initial timestamp and proof. A trademark owner can view the claims and documentation for any listings they have made in their dashboard on the web application. CM Certified listings are also searchable on the present invention's web application.

The present invention may also offer trademark monitoring services, with sources including USPTO applications, domains and popular web sources.

In order to fully embrace the power of the blockchain, the present invention may introduce a CM Token (CMT) to facilitate a decentralized ecosystem that will enable certification consensus of proof of trademark Use.

At the completion of token issuance, the present invention will accept tokens on the existing platform. The smart contract infrastructure may be provided that is needed to support a CM Certification Protocol and related functionality.

A microservices API may interface with the present invention's ecosystem from outside the blockchain network. A web portal for certifiers may seamlessly interact with the present invention's ecosystem.

The present invention may be the sole Accredited Certifier (a party recognized by the present invention as having the ability to certify whether or not submitted documentation supports a Trademark Owner's claim of Use) in the system and the majority of trademarks entering the system may come via an existing web application and partnerships.

Partnerships may be actively developed that will contribute to the growth of various parts of the ecosystem. For example, companies with large trademark portfolios (like cosmetics companies) will be able to quickly and efficiently protect all of the marks they use, in every jurisdiction in which they operate. Through the present invention, partnered online marketplaces will have the ability to both help their end users protect their trademark rights, while simultaneously providing certification that its customers' marks are in Use.

The present invention may aim to grow the number of accredited certifiers on the platform, which may contribute to scaling the present invention.

Token Ecosystem

In order to ensure that usage documentation submitted to the present invention's ecosystem is in fact valid and supports the trademark claim of the submitting user, a CM Token (CMT) may be introduced, which will facilitate the CM Certification Protocol, through the blockchain.

The players in the ecosystem include, at least, the Trademark Owners, Accredited Certifiers and Partners.

Accredited Certifiers are individuals or organizations that have been recognized as having the ability to certify whether or not submitted documentation supports the claim that a Trademark Owner has staked their tokens against. Accredited Certifiers may include a corporation practicing the present invention, lawyers, law firms and other third parties.

Partners are organizations that inherently have the ability to both create Timeline Records and provide certification for the record they have created on behalf of the end user (for example, an online marketplace). These organizations are generally those that contribute to the growth and evolution of the ecosystem.

In order to make a claim of trademark ownership in the present invention's ecosystem, a user must provide a stake of CMT (adhering to a minimum value) and, for example, one CM Reputation Token (CMRT). CMRT may be a valueless internal token used to account for reputation in the present invention's ecosystem, along with their usage documentation. A user's initial documentation will be placed on the blockchain immediately, generating their initial Timeline contract and timestamp of trademark Use. However this documentation will remain uncertified until a certification process completes. Uncertified documentation may not be valid proof of trademark Use and may be unenforceable.

In the first step, a user stakes an amount of CMT (which requires a minimum value determined by the platform). The staked amount is put into an escrow contract along with one of the users CMRT. The following algorithmic sequence then takes place.

An algorithm makes a random selection (weighted based on reputation) of N certifiers from those available and active in the present invention's ecosystem. These certifiers are directed to the documentation provided by the user and are asked to decide if the documentation supports the user's claim.

The chosen certifiers are then given a set amount of time to respond, and if that time lapses, those who have not provided input will be dropped from the process and replaced by another weighted random selection of certifiers. This process will repeat until there are a minimum Z responses required for certification consensus. Once an initial group of certifiers is determined the process may continue.

Whether the chosen certifiers determine that the documentation supports or does not support the user's claim of trademark Use, a certifier is required to stake a CMRT against their decision. And if they don't believe that the specimen does prove Use, they must provide feedback to the user that will aid the user in providing correct documentation.

If the consensus of the chosen certifiers was to reject the claim indicating the documentation was not sufficient, the user will receive the provided feedback from the majority who rejected their documentation and will be required to provide new documentation based on that feedback. The process repeats with the same group of certifiers and will repeat until the consensus is that the documentation is in support of the claim.

A third outcome can occur if the user's documentation and claim are determined to be malicious or fraudulent by the majority. In this case, the process will stop and the user will forfeit the portion of CMT that was to be returned to them. They will also lose their CMRT indicating a loss in reputation.

Finally a reconciliation of tokens (CMRT and CMT) will take place rewarding the chosen certifiers for their work, returning a portion to the user, with the online platform also receiving a portion. The Certifier distributions will be affected by their contributions in the majority vs the minority. The portion awarded to the Certifier is affected positively by how often they voted with the majority but will be affected negatively by the times they voted in the minority.

A loop iteration greater than one (the user required feedback on their documentation one or more times) will shift the portion of tokens returned to the user towards the portion awarded to the certifiers to recognize/reward more work done by the certifiers.

The above process may be the same if a user is appending continued usage documentation or proving Use in a new jurisdiction on an existing Timeline.

Once this process has completed, the user's claim will be considered “CM Certified” and the Accredited Certifiers (chosen certifiers) who participated will be listed as the certifiers of record for the claim.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method comprising the steps of:
receiving by an online platform from a trademark owner a proposed trademark, a claim of use of the proposed trademark, one or more supporting documents purporting to support the claim of use of the proposed trademark, a certification mark token (CMT) and a certification mark reputation token (CMRT), wherein the one or more supporting documents is documentary evidence supporting the use of the trademark, the CMT is a stake of the trademark owner and the CMRT is used to account for a reputation in the online platform;
immediately after receiving the one or more supporting documents, storing by the online platform the one or more supporting documents in a blockchain;
generating by an algorithm operated by the online platform a random selection, from a plurality of available certifiers, of two or more chosen certifiers;
transmitting by the online platform an electronic request to each of the two or more chosen certifiers to review the one or more supporting documents to determine if the one or more supporting documents support the use of the proposed trademark;
receiving by the online platform from each of the two or more chosen certifiers a CMRT;
receiving by the online platform from each of the two or more chosen certifiers a decision regarding whether the one or more supporting documents support the use of the proposed trademark;
determining by the online platform a consensus by the two or more chosen certifiers, wherein the online platform is configured so that:
if the consensus is that the one or more supporting documents support the claim of use of the proposed trademark, the online platform certifies the one or more documents in the blockchain so that the one or more documents may be used as evidence of use of the proposed trademark,
if the consensus is that the one or more supporting documents do not support the claim of use of the proposed trademark, the trademark owner is provided a reason from each of the chosen certifiers that decided the one or more supporting documents do not support the use of the trademark and the trademark owner is allowed to submit additional supporting documents, and
if the consensus is that the one or more documents are malicious or fraudulent and do not support the claim of use of the trademark, the online platform will forfeit the CMT and the CMRT of the trademark owner; and
distributing, by the online platform, the received CMT and CMRT from the trademark owner and the chosen certifiers to the trademark owner and the chosen certifiers based on how many times the trademark owner submitted supporting documents to the online platform and based on how often a decision of each chosen certifier was in a majority or a minority regarding the consensus.
